(19) United States
(12) Patent Application Publication
(10) Pub. No.: US 2016/0240034 A1
(43) Pub. Date: Aug. 18, 2016

(54) Cupcake vending machine

(71) Applicant: Sholanda M. Coleman, Fontana, CA (US)

(72) Inventor: Sholanda M. Coleman, Fontana, CA (US)

(21) Appl. No.: 14/623,116

(22) Filed: Feb. 16, 2015

(51) Int. Cl. G07F 11/62; G05B 15/02

(52) U.S. Cl. CPC G07F 11/62; G05B 15/02

(57) ABSTRACT

A vending system includes a vending control unit; an item dispenser, further including a dispensing door; an item storage and transporter component; a phone handset, further including a phone speaker and a phone microphone; and a phone keypad; such that the vending control unit communicates with a customer via the phone handset and the phone keypad in order to complete a purchase transaction for an item, such that the item storage and transporter component transports the item from an item storage to the item dispenser, whereby the customer retrieves the sold item from the item dispenser. The vending control unit can include a processor; a non-transitory memory; an input/output component; an ordering controller; and a dispensing controller. Also disclosed is a method for vending, including selecting an item, dispensing the item, and retrieving the item.

### CROSS-REFERENCE TO RELATED APPLICATIONS

N/A

### FIELD OF THE INVENTION

The present invention relates generally to the field of vending machines, and more particularly to methods and systems for combining a conventional vending machine with a phone handset and a phone keypad, for the particular purpose of dispensing cupcakes.

### BACKGROUND OF THE INVENTION

Vending machines are well known in the art and remain popular in use for the sale and dispensing of everyday items, including food items.

Pay phone booth used to be commonly in use, but over recent years use has gradually been phasing out, due to the increasing adoption of mobile phones.

For this reason, there are existing installed pay phone booths that are no longer used for their original purpose, and could conceivably be reused for other purposes.

In the past, it has been attempted to combine pay phone booths with a vending machine, but those combination devices were limited in that they only provided a separate vending machine with a separate phone, but did not achieve a useful combination of their inherent functions.

As such, considering the foregoing, it may be appreciated that there continues to be a need for novel and improved devices and methods for combining components of a phone booth with a vending machine.

### SUMMARY OF THE INVENTION

The foregoing needs are met, to a great extent, by the present invention, wherein in aspects of this invention, enhancements are provided to the existing models of vending machines, to include the visual and functional aspects of a phone booth.

In an aspect, a vending system, can include:
a. a vending control unit;
b. an item dispenser, which can further include a dispensing door;
c. an item storage and transporter component, which stores items for sale, and transports a sold item to the item dispenser;
d. a phone handset; and
e. a phone keypad;
such that the vending control unit interacts with a customer via the phone handset and the phone keypad in order to complete a purchase transaction for the sold item, such that the item storage and transporter component transports the sold item from an item storage to the item dispenser, whereby the customer retrieves the sold item from the item dispenser.

In a related aspect, the phone handset can further include a phone speaker and a phone microphone.

In yet a related aspect, the vending system can further include a screen, which displays a graphical user interface to the user, in communication with the vending control unit.

In another related aspect, the vending system can further include a mobile vending device, which is configured to allow a user external access to functions of the vending system via a wireless connection to the vending control unit.

In another related aspect, a method for vending, can include:
a. selecting an item, wherein a user selects an item from a vending machine using a phone handset and a phone keypad, that are parts of the vending machine;
b. dispensing the item, wherein the item is transported from a storage location in the vending machine to an item dispenser in the vending machine;
c. Retrieving the item, wherein the user retrieves the item from the item dispenser.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a vending machine, according to an embodiment of the invention.

FIG. 2 is a schematic diagram illustrating vending system, according to an embodiment of the invention.

FIG. 3 is a schematic diagram illustrating vending control unit, according to an embodiment of the invention.

FIG. 4 is a schematic diagram illustrating a method for vending, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

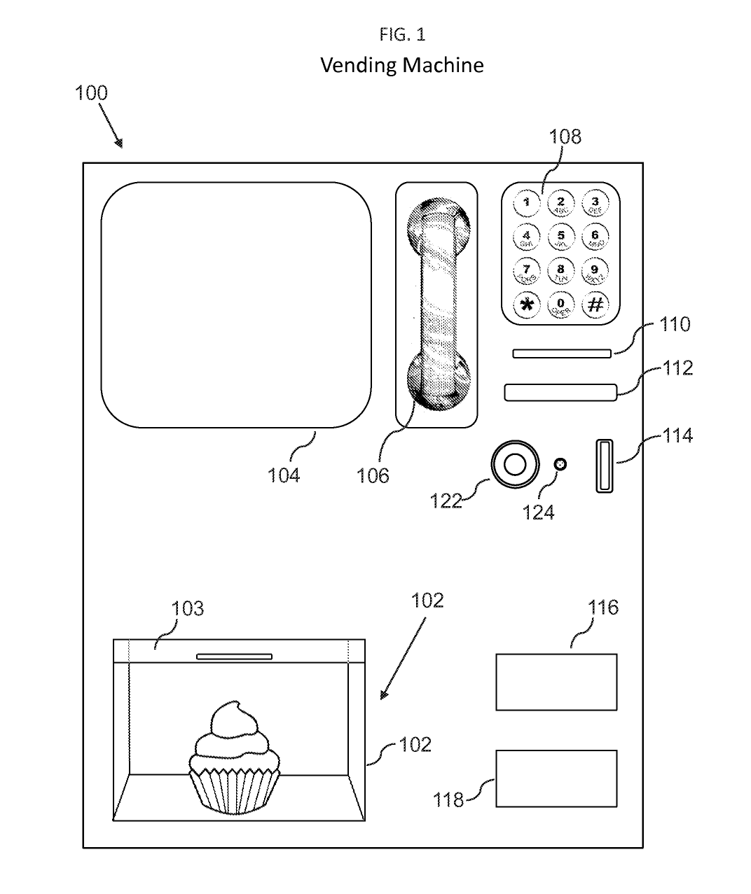

In the following, we describe the structure of an embodiment of a vending machine 100 with reference to FIG. 1, in such manner that like reference numerals refer to like components throughout; a convention that we shall employ for the remainder of this specification.

In an embodiment, a vending machine 100 can be designed as a vending machine that dispenses cupcakes, such that it combines a visual display of a pay-phone booth with a dispensing machine for the purpose of selling cupcakes.

In a related embodiment, the pay-phone booth appearance of the vending machine 100 can be purely visual, such that the handset and phone keypad serves no function other than as a visual novelty item.

In a related embodiment, the pay-phone booth features of the vending machine 100 can aid in the ordering and payment of a cupcake to be dispensed by the vending machine 100.

In an embodiment, as shown in FIG. 1, a vending machine 100 can include:
a) An item dispenser 102, which can further include:
   i. A dispensing door 103, which can further be transparent and configured to open and close by a vertical opening and closing sliding movement, which can either be mechanical or automatic; and
b) A screen 104;
c) A phone handset 106;
d) A phone keypad 108;
e) A system speaker 122;
f) A system microphone 124;
g) A credit card slot 110;
h) A cash bill slot 112;
i) A cash coin slot 114;
j) A cash bill change dispenser 116;
k) A cash coin change dispenser 118;
wherein the vending machine 100 is configured to interact with a customer via the phone handset 106 and the phone keypad 108 in order to complete a purchase transaction for an item, such that the vending machine 100 transports the item from an item storage to the item dispenser 102, whereby the customer retrieves the item from the item dispenser.

In various related embodiments, a vending machine 100 can built using a refurbished or rebuilt phone booth, to which vending machine related component are added, or alternatively a new custom-built vending machine 100 can be constructed, including new components for the phone handset 106 and phone keypad 108, such that the custom-built vending machine 100 resembles a phone booth.

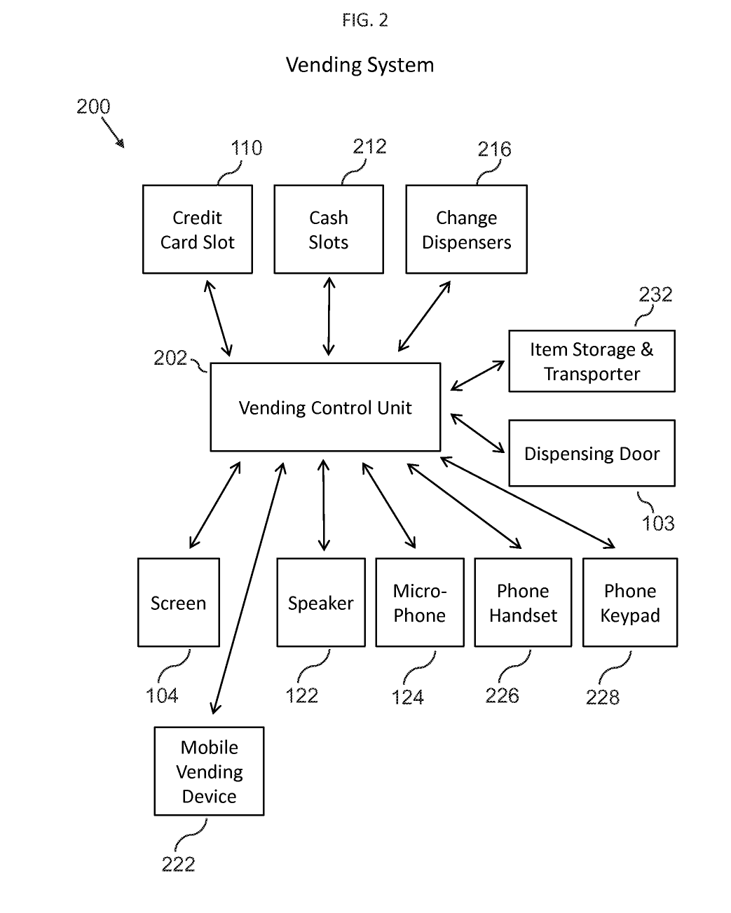

In a related embodiment, as shown in FIG. 2, a vending system 200 can include:
a. A vending control unit 202;
b. A credit card slot 110;
c. Cash slots 212; which can further include a cash bill slot 112 and/or a cash coin slot 114;
d. Change dispensers 216; which can further include a cash bill change dispenser 116 and/or a cash coin change dispenser 118;
e. An item storage and transporter component 232, which can store items for sale, and transport an item to the item dispenser 102;
f. The dispensing door 103; which can be opened in communication with the vending control unit 202, when an item has been transported to the item dispenser 102;
g. The screen 104; which can display a graphical user interface in communication with the vending control unit 202;
h. A system speaker 122;
i. A system microphone 124;
j. A phone handset 226, which can further include a phone speaker and a phone microphone;
k. A phone keypad 228; and
l. A mobile vending device 222, which can be configured to allow a user external access to functions of the vending system via a wireless connection to the vending control unit 202.

In a related embodiment, the item storage and transporter component 232 can be configured to store cupcakes, and transport cupcakes to the item dispenser 102, whereby the vending system 200 is configured to sell cupcakes.

In a related embodiment, the vending control unit 202 can be configured to interact with a customer via the phone keypad 228 and the screen 104, in order to complete a purchase transaction and dispense an item.

In a related embodiment, the vending control unit 202 can be configured to interact with a customer via the phone keypad 228 and the screen 104, in order to obtain a mobile phone number for a mobile phone belonging to the customer, such that the vending control unit can transmit a text message to the mobile phone containing a link to install a vending application, whereby the mobile phone is configured to be a mobile vending device 222.

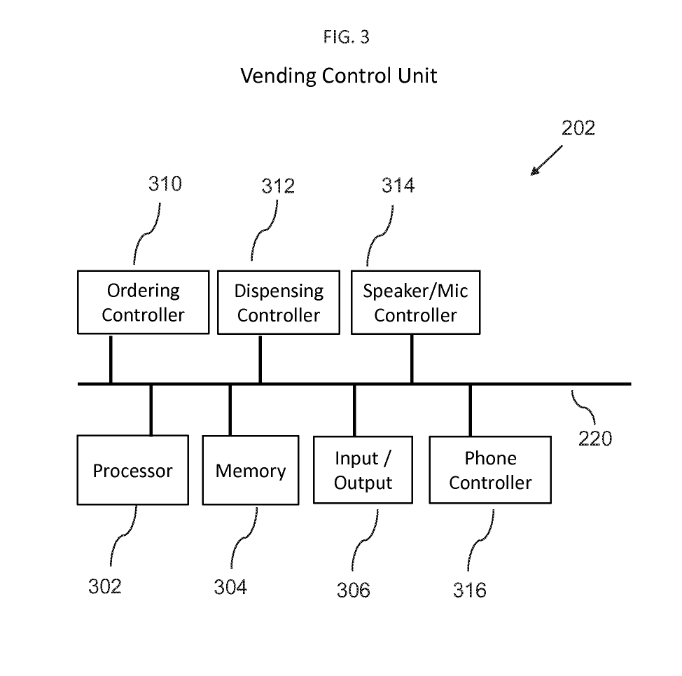

In a related embodiment, as shown in FIG. 3, a vending control unit 202 can include:
a. A processor 302;
b. A non-transitory memory 304;
c. An input/output component 306;
d. An ordering controller 310, which is configured to communicate with a user via the phone handset 226, the phone keypad 228, and/or a mobile app, such that the user can select and purchase an item;
e. A dispensing controller 312, which is configured to communicate with the item storage and transporter component 232 of the vending system 100, in order to transport the selected item to the item dispenser 102, such that the dispensing controller 312 can control opening and closing of the dispensing door 103.
f. A speaker/mic controller 314; and
g. A phone controller 316; all connected via
h. A data bus 220.

In related embodiments, the mobile vending device 222 can include configurations as:
a. A web application, executing in a Web browser;
b. A tablet app, executing on a tablet device, such as for example an Android or iOS tablet device;
c. A mobile app, executing on a mobile device, such as for example an Android phone or iPhone, or any wearable mobile device;
d. A desktop application, executing on a personal computer, or similar device;
e. An embedded application, executing on a processing device, such as for example a smart TV, a game console or other system.

It shall be understood that an executing instance of an embodiment of the system for vending system 200, as shown in FIG. 2, can include a plurality of mobile vending devices 222, which are each tied to one or more users.

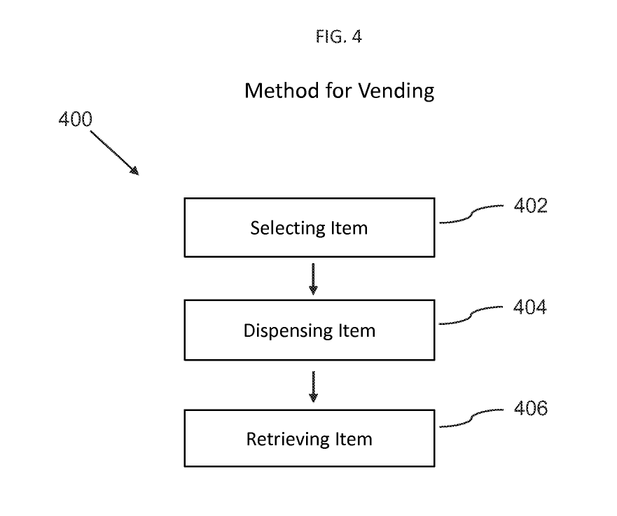

In an embodiment, as illustrated in FIG. 4, a method for vending 400, can include:
a. Selecting an item 402, wherein a user selects an item from a vending machine 100 using a phone handset 226 and a phone keypad 228, that are parts of the vending machine 100;
b. Dispensing the item 404, wherein the item is transported from a storage location in the vending machine 100 to an item dispenser 102 in the vending machine 100;
c. Retrieving the item 406, wherein the user retrieves the item from the item dispenser.

FIGS. 2, 3 and 4 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 2 and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

It shall be understood that the above-mentioned components of the . . . vending control unit 202 and the mobile vending device 222 are to be interpreted in the most general manner.

For example, the processor 302 can include a single physical microprocessor or microcontroller, a cluster of processors, a datacenter or a cluster of datacenters, a computing cloud service, and the like.

In a further example, the non-transitory memory 304 can include various forms of non-transitory storage media, including random access memory and other forms of dynamic storage, and hard disks, hard disk clusters, cloud storage services, and other forms of long-term storage. Similarly, the input/output 306 can include a plurality of well-known input/output devices, such as screens, keyboards, pointing devices, motion trackers, communication ports, and so forth.

Furthermore, it shall be understood that the vending control unit 202 and the mobile vending device 222 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the vending control unit 202 communicates with the mobile vending device 222 over a network, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

2. A vending system, comprising:
a. a vending control unit;
b. an item dispenser, which further comprises:
i. a dispensing door;
c. an item storage and transporter component, which stores items for sale, and transports a sold item to the item dispenser;
d. a phone handset; and
e. a phone keypad;
wherein the vending control unit is configured to interact with a customer via the phone handset and the phone keypad in order to complete a purchase transaction for the sold item, such that the item storage and transporter component transports the sold item from an item storage to the item dispenser, whereby the customer retrieves the sold item from the item dispenser.

3. The vending system of claim 1, wherein the phone handset further comprises a phone speaker and a phone microphone.

4. The vending system of claim 1, wherein the item dispenser further comprises a dispensing door, which is configured to open and close by a vertical opening and closing sliding movement.

5. The vending system of claim 3, wherein the vending control unit is configured to control the opening and closing of the dispensing door.

6. The vending system of claim 1, further comprising a screen, which displays a graphical user interface to the user, in communication with the vending control unit.

7. The vending system of claim 1, further comprising a mobile vending device, which is configured to allow a user external access to functions of the vending system via a wireless connection to the vending control unit.

8. The vending system of claim 1, wherein the vending control unit is configured to transmit a text message to a mobile phone containing a link to install a vending application, such that the mobile phone is configured to be a mobile vending device, which communicates with the vending control unit.

9. The vending system of claim 1, wherein the item storage and transporter component is configured to store cupcakes, and transport a sold cupcake to the item dispenser, whereby the vending system is configured to sell cupcakes.

10. The vending system of claim 1, wherein the vending control unit further comprises:
a. a processor;
b. a non-transitory memory;
c. an input/output component;
d. an ordering controller, which is configured to communicate with the user via the phone handset and the phone keypad, such that the user selects and purchases the sold item; and
e. a dispensing controller, which is configured to communicate with the item storage and transporter component, in order to transport the selected item to the item dispenser.

11. A method for vending, comprises:
a. selecting an item, wherein a user selects an item from a vending machine using a phone handset and a phone keypad, that are parts of the vending machine;
b. dispensing the item, wherein the item is transported from a storage location in the vending machine to an item dispenser in the vending machine;
c. Retrieving the item, wherein the user retrieves the item from the item dispenser.

12. The method for vending of claim 11, wherein the phone handset further comprises a phone speaker and a phone microphone, such that the act of selecting an item further comprises the user listening to the phone speaker, and talking to the phone microphone.

13. The method for vending of claim 11, wherein the act of retrieving the item further comprises opening and closing a dispensing door, which is a part of the item dispenser.

14. The method for vending of claim 11, wherein the act of selecting the item further comprises the user interacting with a graphical user interface on a screen of the vending machine.

15. The method for vending of claim 11, wherein the act of selecting the item further comprises the user receiving a text message on a mobile phone, in order to install a vending application on the mobile phone, whereby the mobile phone is configured as a mobile vending device.

16. The method for vending of claim 11, wherein the act of selecting the item further comprises the user interacting with a mobile vending device, which communicates with the vending machine, in order to select the item.

17. The method for vending of claim 11, wherein the vending machine is configured to store, select, and dispense cupcakes, and wherein the item is a cup cake.
